(19) United States
(12) Patent Application Publication
(10) Pub. No.: US 2025/0041907 A1
(43) Pub. Date: Feb. 6, 2025

(54) Pressure washer

(71) Applicant: Andreas Stihl AG & Co. KG, Waiblingen (DE)

(72) Inventors: Christopher Tost, Auenwald (DE); Alexander Kiebler, Kirchberg an der Murr (DE); Christian Krauer, Weinstadt (DE)

(73) Assignee: Andreas Stihl AG & Co. KG, Waiblingen (DE)

(21) Appl. No.: 18/790,202

(22) Filed: Jul. 31, 2024

(30) Foreign Application Priority Data
Aug. 2, 2023 (EP) 23189259.7

(51) Int. Cl. B08B 3/02

(52) U.S. Cl. CPC B08B 3/026; B08B 2203/0223

(57) ABSTRACT

A pressure washer includes a high-pressure pump by which cleaning fluid can be pressurized in the pressure washer, a hose reel, which is mounted so that it can rotate about an axis of rotation, a reel hose, which can be wound onto and unwound from the hose reel, and a housing. The high-pressure pump is arranged in the housing and includes at least one piston, which can be moved back and forth in a direction of movement to generate pressure on the cleaning fluid. The high-pressure pump has a middle axis running in the direction of movement of the at least one piston. During the operation of the pressure washer, cleaning fluid can be conveyed to the reel hose by the high-pressure pump. The axis of rotation runs transversely to the direction of movement of the at least one piston. The axis of rotation intersects the high-pressure pump.

### CROSS-REFERENCE TO RELATED APPLICATION

This application claims the benefit of European Patent Application EP 23189259.7, filed on Aug. 2, 2023, the content of which is incorporated by reference in its entirety.

### BACKGROUND

A pressure washer is a mechanical device designed to clean surfaces by spraying high-pressure water, which is significantly more effective than a regular garden hose for removing dirt, grime, mold, dust, mud, and other contaminants from surfaces such as buildings, vehicles, and concrete areas. It consists of key components including a motor or engine that powers a water pump, a high-pressure hose to transport the water, a spray gun with a trigger to control the release, and various nozzles to adjust the spray angle and intensity. Pressure washers are commonly used for cleaning driveways, sidewalks, patios, vehicles, boats, building exteriors, and for tasks such as removing mold and stripping paint.

### SUMMARY

Known pressure washers require a large installation space. The present application presents a design that makes a pressure washer as light, compact and as portable as possible.

The arrangement of the high-pressure pump and the hose reel in conventional pressure washers is unfavorable. They are often arranged far apart, such that a supply line from the high-pressure pump to the hose reel is required. This wastes installation space and material. Traditionally, the high-pressure pump and a drive of the high-pressure pump are arranged one behind the other in the direction of movement of the at least one piston of the high-pressure pump. The hose reel is often arranged behind it in the same direction, specifically in the direction of movement of the at least one piston. As a result, a great deal of installation space is required, in particular in the direction of movement of the at least one piston of the high-pressure pump.

In the improved pressure washer according to the disclosure, the axis of rotation of the hose reel runs transversely, in particular perpendicularly, to the direction of movement of the at least one piston. The hose reel and the high-pressure pump are arranged relative to one another in such a manner that the axis of rotation of the hose reel intersects the high-pressure pump. As a result, it is possible to arrange the high-pressure pump and the hose reel very close to one another. Consequently, a long connecting line between the high-pressure pump and the hose reel is not required. In addition, little installation space is required in the direction of movement of the at least one piston of the high-pressure pump. As a result, a compact design of the pressure washer is made possible.

In particular, the middle axis of the high-pressure pump is a central axis of the at least one piston. If the high-pressure pump only comprises a single piston, the middle axis is the longitudinal middle axis of the piston. If the high-pressure pump comprises a plurality of pistons, the middle axis is an axis of symmetry with respect to the set of all pistons. For example, the pistons can be arranged on an imaginary circular line. The middle axis then runs through the center point of the circular line. In this case, the middle axis is expediently at the same spacing to all pistons. This spacing is measured perpendicularly to the direction of movement of the at least one piston. However, it can also be provided that the pistons are arranged in a row, in particular on an imaginary straight line. The middle axis then runs through the straight line and divides the set of all pistons along the straight line into two equal halves.

In a particular configuration, the high-pressure pump comprises a swash plate. The swash plate is mounted so that it can rotate around a plate rotation axis. Expediently, the swash plate drives the at least one piston of the high-pressure pump during the operation of the pressure washer. In particular, the middle axis of the high-pressure pump runs coaxially to the plate rotation axis of the swash plate.

In particular, the high-pressure pump comprises a pump inlet. The pump inlet is also referred to as the fluid inlet. In particular, the pump inlet is designed such that fluid can enter the high-pressure pump through the pump inlet in the direction of movement of the at least one piston.

Advantageously, the axis of rotation of the hose reel intersects the middle axis of the high-pressure pump. In particular, the axis of rotation of the hose reel and the middle axis of the high-pressure pump are oriented perpendicularly relative to one another.

The hose reel has a reel spacing to the middle axis measured in the direction of the axis of rotation of the hose reel. The pressure washer has a maximum width measured in the direction of the axis of rotation. Advantageously, the reel spacing is at most 55%, in particular at most 40%, in particular at most 30% of the maximum width. As a result, the hose reel is arranged at a small reel spacing to the middle axis. As a result, the pressure washer is designed to be compact.

The hose reel has a reel width measured in the direction of the axis of rotation of the hose reel. Advantageously, the reel spacing is at most 70%, in particular at most 55% of the reel width. As a result, a compact design of the pressure washer, in particular with respect to the direction transverse, in particular the direction perpendicular to the middle axis of the high-pressure pump, is also possible.

Expediently, the reel width is at most 60%, in particular at most 50% of the maximum width of the pressure washer. As a result, the pressure washer can be designed to be compact, in particular with respect to the direction transverse, in particular the direction perpendicular to the middle axis.

In particular, the hose reel is arranged in the region of an outer wall of the housing. Expediently, the hose reel is arranged outside the housing. However, it can also be provided that the hose reel is only partially covered by an outer wall of the housing. It can also be provided that the hose reel is arranged inside the housing.

In particular, the housing limits the pressure washer at least partially to the outside.

The high-pressure pump has a rigid base body. In particular, the pressure washer has a rigid connecting element. In particular, the connecting element is part of the high-pressure pump. In contrast to a flexible hose for conducting cleaning fluid, the connecting element is rigid. In particular, the connecting element is a die-cast part. Advantageously, the connecting element is arranged between the hose reel and the rigid base body of the high-pressure pump, in particular with respect to the direction transverse, in particular the direction perpendicular to the middle axis. In particular, the rigid connecting element is directly connected to the rigid base body of the high-pressure pump. In particular, the rigid base body and the rigid connecting element form a rigid structural unit of the pressure washer. In particular, the pressure washer has a fluid distributor piece. Expediently, the fluid distributor piece is held in the rigid connecting element. In particular, the rigid connecting element is arranged between the fluid distributor piece and the rigid base body of the high-pressure pump, in particular with respect to the direction transverse, in particular with respect to the direction perpendicular to the middle axis. Expediently, the fluid distributor piece is provided for transferring the cleaning fluid into the hose reel, in particular into the reel hose. In particular, the hose reel is rotatably mounted on the fluid distributor piece. Expediently, the pressure washer is designed in such a manner that cleaning fluid can flow from the rigid base body of the high-pressure pump through the connecting element to the fluid distributor piece during the operation of the pressure washer. In particular, no flexible line piece, in particular no flexible hose, is arranged between the fluid distributor piece and the high-pressure pump. In particular, no flexible line piece, in particular no flexible hose, is arranged between the fluid distributor piece and the base body of the high-pressure pump.

In an advantageous further development, it is provided that the high-pressure pump projects into the hose reel in the direction transverse to the middle axis, in particular in the direction perpendicular to the middle axis, in particular in the direction of the axis of rotation of the hose reel. In particular, the connecting element of the high-pressure pump projects into the hose reel in the direction transverse to the middle axis, in particular in the direction perpendicular to the middle axis, in particular in the direction of the axis of rotation of the hose reel. A particularly compact design of the pressure washer is possible. The connecting element can be designed to be comparatively short and further installation space is saved by projecting the connecting element into the hose reel.

Advantageously, the high-pressure pump overlaps the hose reel with respect to the direction transverse, in particular perpendicular to the middle axis, in particular with respect to the direction of the axis of rotation over at least 30% of the reel width. In particular, the connecting element overlaps the hose reel with respect to the direction transverse, in particular perpendicular to the middle axis, in particular with respect to the direction of the axis of rotation over at least 30% of the reel width.

On its inner outer side turned towards the high-pressure pump, the hose reel advantageously has a radially inner receiving chamber in relation to the axis of rotation. In particular, the receiving chamber extends radially in relation to the axis of rotation, starting from the axis of rotation. In particular, the receiving chamber is designed to receive a cleaning supply line for adding cleaning agent to the cleaning fluid. As a result, a compact design of the pressure washer is also possible.

The receiving chamber has a maximum diameter measured perpendicularly, in particular radially, to the axis of rotation. In particular, the maximum diameter is greater than a diameter of the fluid distributor piece measured in the direction perpendicular, in particular radial, to the axis of rotation. As a result, there is sufficient space available in the receiving chamber to receive the cleaning supply line.

In particular, the connecting element comprises a cleaning supply opening for adding cleaning agent to the cleaning fluid. Expediently, the cleaning supply opening is arranged in the connecting element. In particular, the cleaning supply opening is arranged in the region of the hose reel with respect to the direction of the axis of rotation. As a result, even with a compact design of the pressure washer, the addition of cleaning agent to the cleaning fluid can be carried out in a simple manner.

Expediently, the pressure washer comprises a battery pack. In particular, the battery pack is the only source of energy for the pressure washer. In particular, the pressure washer is a battery-powered cordless pressure washer.

In particular, the pressure washer can be carried. In particular, the pressure washer has no wheels.

In particular, the battery pack is used for supplying power to a drive for the high-pressure pump. Expediently, the pressure washer has a battery compartment for receiving the battery pack. Advantageously, the battery compartment and the hose reel overlap at least partially with respect to the direction of the axis of rotation. In particular, the battery compartment and the high-pressure pump overlap at least partially with respect to the direction of the axis of rotation. Expediently, the high-pressure pump, the drive for the high-pressure pump and the battery compartment are arranged one behind the other with respect to the direction of the middle axis, in particular with respect to the direction of movement. Due to this type of arrangement, the pressure washer can be designed to be very compact. In particular, the pressure washer has a handle. The pressure washer can be carried using the handle. Expediently, the high-pressure pump, hose reel and battery pack are arranged in such a manner that the center of gravity of the pressure washer is below the handle. As a result, it is possible to comfortably carry the pressure washer.

In an advantageous further development, the hose reel forms a part of the outer contour of the pressure washer. In particular, the hose reel protrudes in the direction transverse to the middle axis, in particular in the direction perpendicular to the middle axis, in particular in the direction of the axis of rotation with less than 35% of its reel width above an outer contour of the housing.

### BRIEF DESCRIPTION OF THE DRAWINGS

FIG. 1 shows a perspective representation of a pressure washer.

FIG. 2 shows a top view of the pressure washer shown in FIG. 1.

FIG. 3 shows a side view of the pressure washer from FIG. 1.

FIG. 4 shows a sectional view of a cut along section line IV-IV from FIG. 3.

FIG. 5 shows a perspective sectional view of a cut along section line VI-VI from FIG. 4.

FIG. 6 shows a sectional view of the cut along section line VI-VI from FIG. 4.

FIG. 7 shows a sectional view of a cut along section line VII-VII from FIG. 4.

FIG. 8 shows a sectional view of the cut along section line VIII-VIII from FIG. 4.

FIG. 9 shows a perspective view of the high-pressure pump and the drive of the high-pressure pump of the pressure washer from FIG. 1.

FIG. 10 shows a perspective view of the high-pressure pump, the drive and the hose reel of the high-pressure pump of the pressure washer from FIG. 1.

FIG. 11 shows a perspective view of the hose reel and the reel hose of the pressure washer from FIG. 1.

FIG. 12 shows a sectional view of a cut along the angled sectional line XII-XII from FIG. 2.

### DETAILED DESCRIPTION

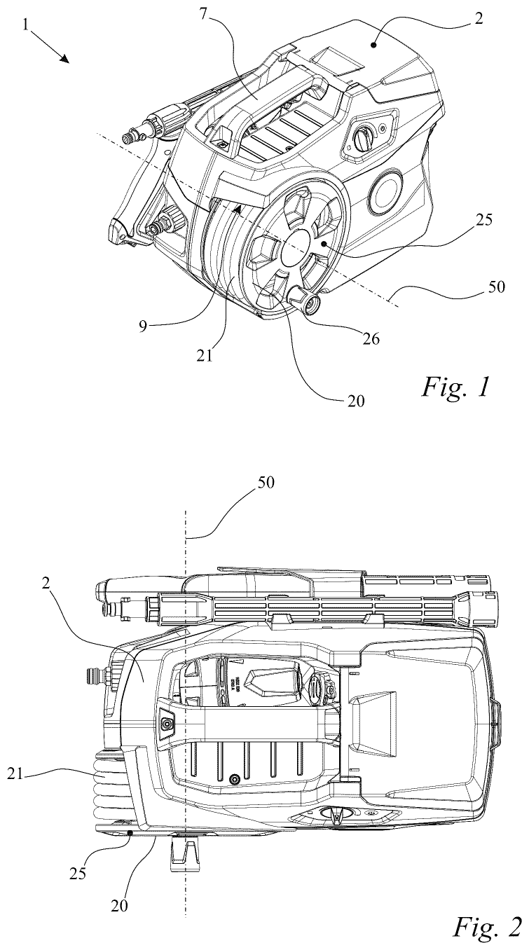

FIG. 1 shows a pressure washer 1. The pressure washer 1 is designed for cleaning objects with pressurized cleaning fluid. In the exemplary embodiment, the pressure washer 1 is portable. The pressure washer 1 has a handle 7. The pressure washer 1 can be carried by the handle 7. In normal operation, it is intended that the pressure washer 1 is set down. In this exemplary embodiment, the pressure washer 1 is a battery-powered cordless pressure washer.

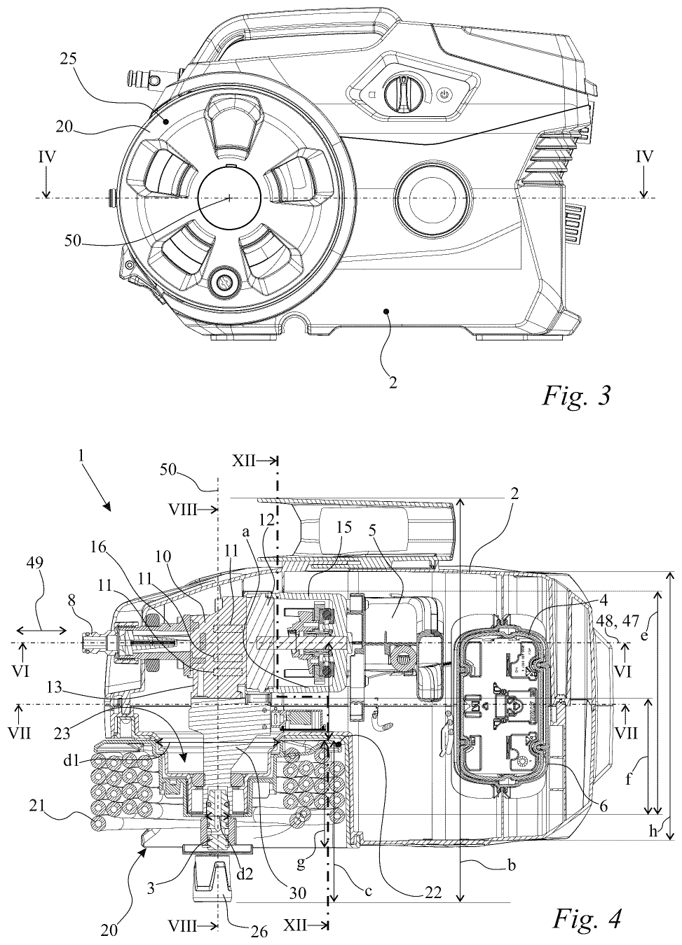

The pressure washer 1 has a housing 2. The housing 2 limits the pressure washer 1 at least partially to the outside. The pressure washer 1 has a hose reel 20. As shown in FIGS. 1 to 4, the hose reel 20 is mounted so that it can rotate about an axis of rotation 50. The pressure washer 1 comprises a reel hose 21. The reel hose 21 can be wound onto and unwound from the hose reel 20. The reel hose can be wound onto and unwound from the hose reel 20. A high-pressure pump 10 is arranged in the housing 2, as shown in FIG. 4, for example. Cleaning fluid can be pressurized in the pressure washer 1 by means of the high-pressure pump 10. By means of the high-pressure pump 10, the cleaning fluid can be pressurized to at least 10 bar, in particular at least 15 bar, in particular at least 30 bar, in particular at least 100 bar. In particular, with the high-pressure pump 10, the cleaning fluid can be pressurized to a maximum of 600 bar, in particular to a maximum of 500 bar. The high-pressure pump 10 comprises at least one piston 11. The at least one piston 11 is shown schematically in FIG. 4. The at least one piston 11 can be moved back and forth in a direction of movement 49 to generate pressure on the cleaning fluid. In the exemplary embodiment, the high-pressure pump 10 comprises three pistons 11.

The high-pressure pump has a middle axis 48 running in the direction of movement 49 of the at least one piston 11. The middle axis 48 is a central axis of the high-pressure pump 10. In particular, the middle axis 48 of the high-pressure pump 10 is a central axis of the at least one piston 11. If the high-pressure pump 10 only comprises a single piston 11, the middle axis 48 is the longitudinal middle axis of the piston. In the exemplary embodiment, the high-pressure pump 10 comprises a plurality of pistons 11. In this case, the middle axis 48 runs in the middle of the plurality of pistons 11. The middle axis 48 is an axis of symmetry with respect to the set of all pistons 11. As shown in FIG. 8, the pistons 11 can be arranged on an imaginary circular line 17. The imaginary circular line is shown with a dashed line in FIG. 8. The pistons 11 are also shown schematically with a dashed line. The middle axis 48 runs through the center point of the circular line 17. In the exemplary embodiment, the middle axis 48 has the same spacing to all pistons 11. This spacing is measured vertically, in particular radially to the direction of movement 49 of the at least one piston 11. However, it can also be provided that the pistons 11 are arranged in a row, in particular on an imaginary straight line. The middle axis 48 then runs through the straight line and divides the set of all pistons 11 along the straight line into two equal halves. The middle axis 48 is then in the middle of the total set of all pistons 11. Thereby, the middle axis 48 can also run through one of the pistons 11.

In the exemplary embodiment, the high-pressure pump 10 comprises a swash plate 12, as shown in FIG. 4. The swash plate 12 is mounted so that it can rotate about a plate rotation axis 47. During the operation of the pressure washer 1, the swash plate 12 drives the at least one piston 11 of the high-pressure pump 10. The swash plate 12 rotates around the plate rotation axis 47. Thereby, the swash plate 12 presses the at least one piston 11 in the direction of the cleaning fluid. In particular, the cleaning fluid is pressurized in a piston chamber (not shown). By moving the piston 11 in the direction of movement 49 towards the cleaning fluid, the volume of the piston chamber is reduced. When the at least one piston 11 moves towards the cleaning fluid, a resetting element (not shown), such as a spring, is tensioned. Due to the restoring force of the spring, the at least one piston 11 is then pressed back in the direction away from the cleaning fluid. The swash plate 12 subsequently ensures a movement of the at least one piston 11 in the opposite direction again. The swash plate 12 has an inclined surface for contact with the piston 11. The inclined surface runs at an angle to the plate rotation axis 47. The middle axis 48 of the high-pressure pump 10 runs coaxially to the plate rotation axis 47 of the swash plate 12. During the operation of the pressure washer 1, cleaning fluid can be conveyed to the reel hose 21 by means of the high-pressure pump 10.

The high-pressure pump 10 has an inlet valve (not shown). The cleaning fluid can enter the piston chamber through the inlet valve. In the exemplary embodiment, an inlet valve is provided for each piston 11. The inlet valve is a non-return valve. If the cleaning fluid in the piston chamber is pressurized, the inlet valve closes.

The high-pressure pump 10 has an outlet valve (not shown). The cleaning fluid can exit the piston chamber through the outlet valve and, in particular, continue to flow in the direction of the reel hose 21. In the exemplary embodiment, an exhaust valve is provided for each piston 11. The outlet valve is a non-return valve. It prevents backflow from the reel hose 21 into the piston chamber.

As shown in particular in FIG. 4, the axis of rotation 50 of the hose reel 20 runs transversely to the direction of movement 40 of the at least one piston 11. In particular, the axis of rotation 50 runs perpendicularly to the direction of movement 49 of the at least one piston 11. The axis of rotation 50 of the hose reel 20 intersects the high-pressure pump 10.

The high-pressure pump 10 comprises a base body 13. The at least one piston 11 is arranged in the base body 13. The high-pressure pump 10 comprises at least one piston 11. Each piston 11 is assigned a piston chamber in which the cleaning fluid can be pressurized. Each piston chamber is assigned an inlet valve (not shown). Each piston chamber is assigned an outlet valve (not shown). The inlet valve is part of the high-pressure pump 10. The outlet valve is part of the high-pressure pump 10. The piston chamber is part of the high-pressure pump 10. The inlet valve is held in the base body 13. The outlet valve is held in the base body 13. The component that causes the back and forth movement of the at least one piston 11 in the direction of movement 49 is part of the high-pressure pump 10. In the exemplary embodiment, the swash plate 12 is part of the high-pressure pump 10. It can also be provided that the back and forth movement of the at least one piston 11 is effected by a crankshaft. In this case, the crankshaft is part of the high-pressure pump 10. The swash plate 12 includes a shaft 14. The high-pressure pump 10 comprises a shaft housing 15. The shaft 15 is rotatably mounted in the same housing 15. If the at least one piston 11 is driven by a crankshaft for back and forth movement in the direction of movement 49, the crankshaft is rotatably mounted in the shaft housing 15.

The pressure washer 1 comprises a drive 5. The drive 5 is used to drive the high-pressure pump 10. The drive 5 is not part of the high-pressure pump 10. In the exemplary embodiment, the drive is an electric motor. In particular, the drive 5 is a DC motor. In particular, the drive 5 is a brushless DC motor. The brushless DC motor is also known as an EC motor.

The high-pressure pump 10 comprises an inlet nozzle 16. Cleaning fluid can enter the base body 13 of the high-pressure pump 10 through the inlet nozzle 16. The inlet nozzle 16 is fixed to the base body 13. The inlet nozzle 16 is fixed directly to the base body 13 in particular. The inlet nozzle 16 is rigid. The inlet nozzle 16 does not comprise a flexible element such as a flexible hose. The inlet nozzle 16 is a die-cast part in particular. A flexible hose for supplying cleaning fluid can be attached to the inlet nozzle 16. In the exemplary embodiment, a coupling 8 is provided for this purpose. The coupling 8 is not part of the high-pressure pump 10. The hose for supplying the cleaning fluid can be plugged to the coupling 8 by means of a suitable counter coupling. However, it can also be provided that the hose for supplying the cleaning fluid is fastened to the inlet nozzle 16 by means of a clamp or the like. Starting from the inlet nozzle, the cleaning fluid is supplied to the at least one inlet valve of the piston chamber of the at least one piston 11. In the exemplary embodiment, the cleaning fluid is supplied from the inlet nozzle 16 to a plurality of inlet valves of the plurality of pistons 11. The inlet nozzle 16 represents a common inlet of cleaning fluid for all pistons 11 of the high-pressure pump 10. The inlet nozzle 16 extends along the direction of movement 49. The inlet nozzle 16 protrudes beyond the base body 13 of the high-pressure pump 10 in the direction of movement 49, in the direction away from the shaft housing 15.

The high-pressure pump 10 comprises a connecting element 30. The connecting element 30 is also referred to as the pump outlet of the high-pressure pump 10. The connecting element 30 represents a common outlet for the cleaning fluid exiting the outlet valves of the plurality of pistons 11. The connecting element 30 is designed to be rigid. The connecting element 30 is fixed to the base body 13 of the high-pressure pump 10. In particular, the connecting element 30 is fixed directly to the base body 13 of the high-pressure pump 10. The connecting element 30 does not comprise a flexible hose. In the exemplary embodiment, the connecting element 30 is a die-cast part. The connecting element 30 is designed in one piece. The connecting element 30 extends along a direction that runs transverse to the direction of movement 49, in particular perpendicular to the direction of movement 49, in particular radial to the middle axis 48.

The pressure washer 1 comprises a fluid distributor piece 3. The fluid distributor piece 3 connects the connecting element 30 directly to the hose reel 20, in particular to the reel hose 21. The hose reel 20 is rotatably mounted on the fluid distributor piece 3. The cleaning fluid is supplied into the reel hose 21 through the fluid distributor piece 3. The fluid distributor piece 3 is held in the rigid connecting element 30 of the high-pressure pump 10. The fluid distributor piece 3 is rigid. The fluid distributor piece 3 does not comprise a flexible hose. The rigid connecting element 30 is directly connected to the rigid base body 13 of the high-pressure pump 10. During the operation of the pressure washer 1, cleaning fluid can flow from the base body 13 of the high-pressure pump 10 through the connecting element 30 of the high-pressure pump 10 to the fluid distributor piece 3. The fluid distributor piece 3 is not part of the high-pressure pump 10. The high-pressure pump 10 does not comprise any flexible supply lines or discharge lines for cleaning fluid, for example in the form of hoses.

In the exemplary embodiment, the hose reel 20 is arranged relative to the high-pressure pump 10 such that the axis of rotation 50 of the hose reel 20 intersects the middle axis 48 of the high-pressure pump 10. In particular, the axis of rotation 50 of the hose reel 20 and the middle axis 48 of the high-pressure pump 10 are oriented perpendicularly relative to one another. The axis of rotation 50 of the hose reel 20 runs in particular radially to the middle axis 48 of the high-pressure pump 10.

If the pressure washer 1 is placed on a horizontal plane with a placement surface provided for this purpose, the axis of rotation 50 of the hose reel 20 runs parallel to the horizontal plane in the exemplary embodiment. If the pressure washer 1 is placed on the horizontal plane with the placement surface provided for this purpose, the middle axis 48 runs parallel to the horizontal plane.

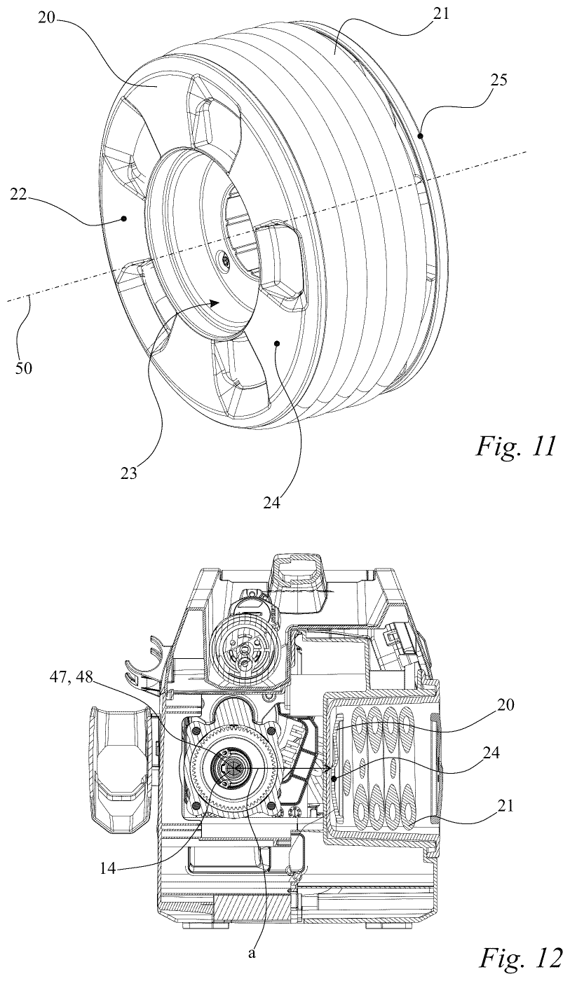

As shown in FIG. 11, the hose reel 20 comprises a first side wall 24. The hose reel 20 comprises a second side wall 25. The first side wall 24 is spaced from the second side wall 25 in the direction of the axis of rotation 50 of the hose reel 20. A receiving chamber for the reel hose 21 is formed between the side walls 24 and 25. The reel hose 21 is wound or coiled up between the side walls 24 and 25. As can be seen in the perspective view in FIG. 10, the first side wall 24 is arranged closer to the high-pressure pump 10 than the second side wall 25. The first side wall 24 is on the inside. The first side wall 24 is turned towards the high-pressure pump 10.

The fluid distributor piece 3 is arranged closer to the second side wall 25 than to the first side wall 24 with respect to the direction of the axis of rotation 50. The fluid distributor piece 3 is arranged with respect to the direction of the axis of rotation 50, in particular in the region of the second side wall 24.

As shown in FIGS. 4, 8 and 12, the hose reel 20 has a reel spacing a to the middle axis 48 of the high-pressure pump 10 measured in the direction of the axis of rotation 50 of the hose reel 20. In particular, the reel spacing a between the hose reel 20 and the middle axis 48 corresponds to the spacing between the middle axis 48 and the first side wall 24 measured in the direction of the axis of rotation 50. The hose reel 20 only includes the parts that can rotate around the axis of rotation 50.

As shown in FIGS. 4 and 8, the pressure washer 1 has a maximum width b measured in the direction of the axis of rotation 50 of the hose reel 20. When determining the maximum width b, all components of the pressure washer 1 are taken into account. The reel spacing a is at most 50%, in particular at most 40%, in the exemplary embodiment at most 30% of the maximum width b. The reel spacing a is at least 10%, in the exemplary embodiment at least 20% of the maximum width b.

As shown in FIG. 4, the housing 2 has a maximum internal width h measured in the direction of the axis of rotation 50 of the hose reel 20. The reel spacing a is at most 50%, in the exemplary embodiment at most 40% of the maximum internal width h. The reel spacing a is at least 20%, in the exemplary embodiment at least 30% of the maximum internal width h.

The hose reel 20 has a reel width c as shown in FIGS. 4 and 8, measured in the direction of the axis of rotation 50 of the hose reel 20. All components of the hose reel 20 are taken into account when determining the reel width c. As shown in FIG. 1, the hose reel 20 comprises a crank pin 26. The crank pin 26 is part of the hose reel 20. The crank pin 26 is to be taken into account when ascertaining the reel width c. In the exemplary embodiment, the reel width c is measured from the side of the first side wall 24 turned towards the high-pressure pump 10 to the outer longitudinal end of the crank pin 26.

The reel spacing a is at most 70%, in particular at most 60%, in the exemplary embodiment at most 55% of the reel width c.

The reel width c is at most 60%, in the exemplary embodiment at most 50% of the maximum width b of the pressure washer 1.

The reel width c is at least 30%, in the exemplary embodiment at least 40% of the maximum width b of the pressure washer 1.

The reel width c is at most 80%, in the exemplary embodiment at most 70% of the maximum internal width h of the housing 2.

The reel width c is at least 40%, in the exemplary embodiment at least 50% of the maximum internal width h of the housing 2.

The high-pressure pump 10 has a pump width e measured in the direction of the axis of rotation 50 of the hose reel 20. This is shown in FIGS. 4 and 8. The pump width e of the high-pressure pump 10 is at least 40%, in the exemplary embodiment at least 50% of the maximum width b of the pressure washer 1. The pump width e is at most 70%, in the exemplary embodiment at most 60% of the maximum internal width h.

The pump width e of the high-pressure pump 10 is at least 70%, in the exemplary embodiment at least 80%, of the maximum internal width h of the housing 2 of the pressure washer 1. The pump width e is at most 95%, in the exemplary embodiment at most 90% of the maximum internal width h.

The connecting element 30 has a connection width f measured in the direction of the axis of rotation 50 of the hose reel 20, as shown in FIGS. 4 and 8. The connection width f is at least 15%, in the exemplary embodiment at least 25% of the maximum width b of the pressure washer 1. The connection width f is at most 45%, in the exemplary embodiment at most 35% of the maximum width b of the pressure washer 1.

As shown in particular in FIGS. 4 and 8, no flexible line piece, in particular no flexible hose, is arranged between the fluid distributor piece 3 and the high-pressure pump 10, in particular between the fluid distributor piece 3 and the base body 13 of the high-pressure pump 10. This statement refers to the components of the pressure washer 1 that are involved in supplying the cleaning fluid from the high-pressure pump 10 to the fluid distributor piece 3. All of these components are designed to be rigid. In the exemplary embodiment, all of these components—with the exception of sealing rings and screws—are die-cast components.

The connecting element 30 projects into the hose reel 20 in the direction of the axis of rotation 50. The high-pressure pump 10, in particular the connecting element 30, and the hose reel 20 overlap with respect to the direction of the axis of rotation 50 of the hose reel 20. The hose reel 20 extends over the high-pressure pump 10, in particular the connecting element 30 of the high-pressure pump 10. The high-pressure pump 10, in particular the connecting element 30, overlaps the hose reel 20 with respect to the direction of the axis of rotation 50 over at least 30% of the reel width c.

The hose reel 20 has a receiving chamber 23 on its inner outer side 22 turned towards the high-pressure pump 10. This is shown in particular in FIGS. 10 and 11. The inner outer side 22 is formed by the first side wall 24. The inner outer side 22 is an outer side of the first side wall 24. The receiving chamber 23 is located radially inwards with respect to the axis of rotation 50. This can also be seen in FIGS. 4 and 8. In the exemplary embodiment, the receiving chamber 23 is designed to receive a cleaning supply line 32. The cleaning supply line 32 is used to add cleaning agent to the cleaning fluid. The cleaning supply line 32 is shown in FIGS. 8 and 10. The cleaning supply line 32 is not part of the connecting element 30. The cleaning supply line 32 is not part of the high-pressure pump 10.

As shown in FIG. 4, the receiving chamber 23 has a maximum diameter d1 measured in the direction perpendicular to the axis of rotation 50. The fluid distributor piece 3 has a diameter d2 measured in the direction perpendicular to the axis of rotation. The diameter d2 is the outer diameter of the fluid distributor piece 3. The maximum diameter d1 of the receiving chamber 23 is greater than the diameter d2 of the fluid distributor piece 3. The high-pressure pump 10, in particular the connecting element 30, has a cleaning supply opening 31, as shown in FIG. 8. The cleaning supply opening 31 is used to add cleaning agent to the cleaning fluid. Cleaning agent can be introduced into the high-pressure pump 10, in particular into the connecting element 30, through the cleaning supply opening 31. The cleaning supply opening 31 is arranged in the region of the hose reel 20 with respect to the direction of the axis of rotation 50 of the hose reel 20. The hose reel 20 engages over the cleaning supply opening 31. It can be provided that the cleaning supply opening 31 is arranged in the region of a cross-sectional constriction for the cleaning fluid. This region is known as a Venturi nozzle.

As can be seen in FIG. 4 in particular, the hose reel 20 and the high-pressure pump 10 overlap with respect to the direction of movement 49. In the exemplary embodiment, the hose reel 20 completely overlaps the high-pressure pump 10 with respect to the direction of movement 49. The high-pressure pump 10 is arranged completely in the region of the hose reel 20 with respect to the direction of movement 49.

The hose reel 20 and the high-pressure pump 10 are arranged one behind the other with respect to the direction of the axis of rotation 50 of the hose reel 20. Viewed in the direction of movement 49, the high-pressure pump 10 and the hose reel 20 are next to one another.

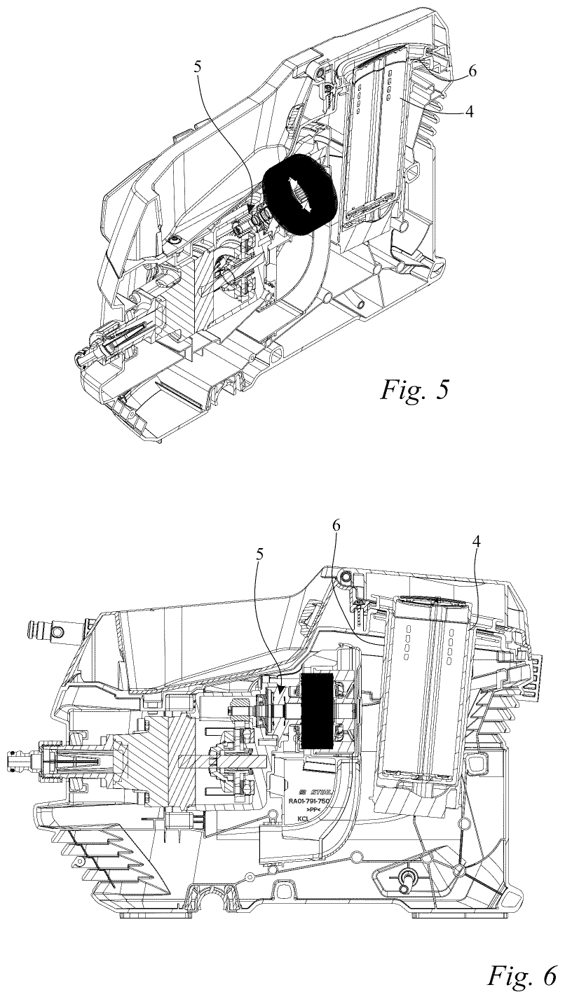

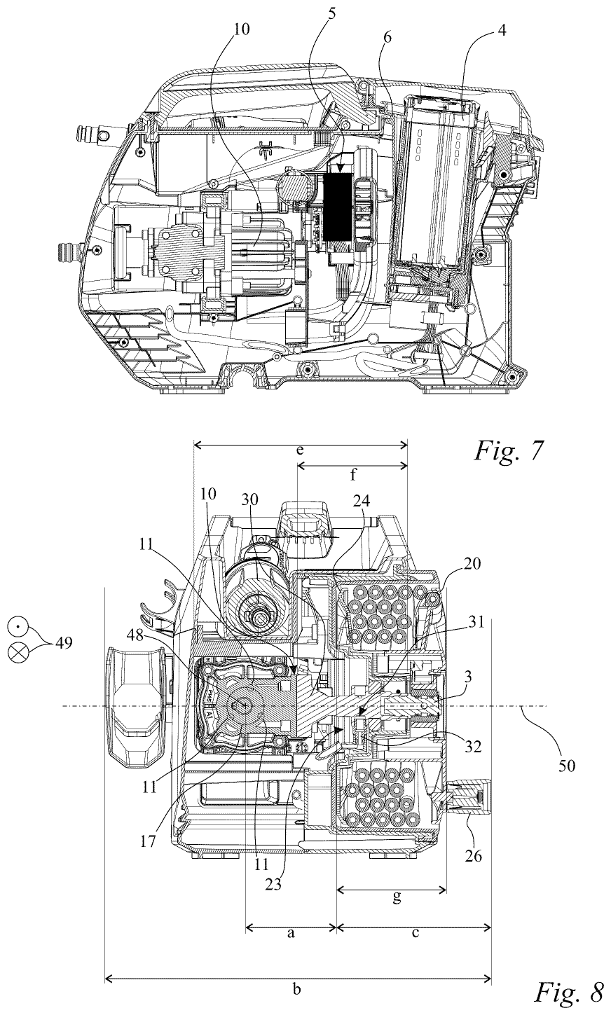

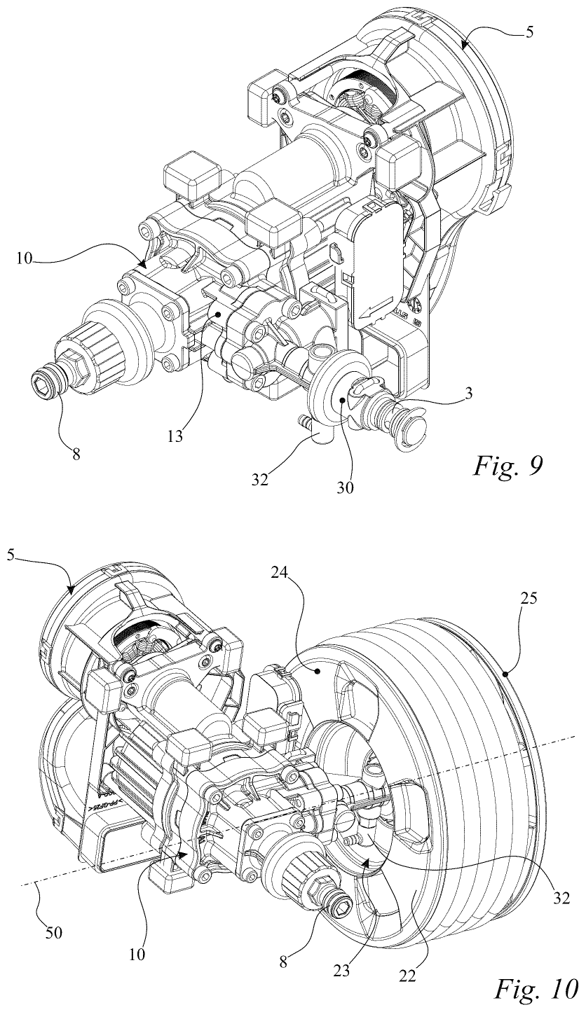

The pressure washer 1 comprises a battery pack 4. The battery pack is shown in FIGS. 4 to 7. The battery pack 4 is used for supplying power to the drive 5 of the high-pressure pump 10. As also shown in FIGS. 4 to 7, the pressure washer 1 comprises a battery compartment 6. The battery compartment 6 is used to receive the battery pack 4. The battery pack 4 can be inserted into the battery compartment 6 through a compartment opening in the battery compartment 6. The compartment opening runs closed around the direction of insertion of the battery pack 4. In the exemplary embodiment, the battery compartment 6 is arranged in the housing 2. In the exemplary embodiment, the battery pack 4 is arranged in the housing 2. As shown in FIG. 4, the battery compartment 6 and the hose reel 20 overlap at least partially with respect to the direction of the axis of rotation 50 of the hose reel 20. The battery compartment 6 and the high-pressure pump 10 overlap at least partially with respect to the direction of the axis of rotation 50 of the hose reel 20. Viewed in the direction of movement, the battery compartment 6 overlaps both the high-pressure pump 10 and the hose reel 20. With respect to the direction of movement 49, the battery compartment 6 and the high-pressure pump 10 are arranged one behind the other. With respect to the direction of movement 49, the battery compartment 6 and the hose reel 20 are arranged one behind the other. With respect to the direction of movement 49, the drive 5 is arranged between the battery compartment 6 and the high-pressure pump 10. The drive 5 is arranged in the housing 2. The high-pressure pump 10 is arranged in the housing 2. The high-pressure pump 10, the drive 5 for the high-pressure pump 10 and the battery compartment 6 are arranged one behind the other with respect to the direction of the middle axis 48, in particular with respect to the direction of movement 49.

As can be seen in particular in FIGS. 1 to 3, the hose reel 20 forms a part of the outer contour of the pressure washer 1. In particular, the second side wall 25 forms a part of the outer contour of the pressure washer 1. In particular, the reel hose 21 forms a part of the outer contour of the pressure washer 1. In the exemplary embodiment, the hose reel 20, in particular the second side wall 25, continues the outer contour of the housing 2 of the pressure washer 1.

In the exemplary embodiment, the hose reel 20 is arranged outside the housing 2.

The second side wall 25 is turned away from the high-pressure pump 10.

As shown in FIG. 4, the hose reel 20 protrudes beyond the outer contour of the housing 2 by less than 35% of its reel width c in the direction of the axis of rotation 50 of the hose reel 20.

The hose reel 20 has a side width g. The side width g is shown in FIG. 4. The side width g is measured in the direction of the axis of rotation 50 of the hose reel 20. The side width g corresponds to the greatest spacing of the outer sides of the side walls 24 and 25 relative to one another. The crank pin 26 is not part of the second side wall 25. A holder provided on the second side wall 25 of the second side wall 25 does not count as part of the second side wall 25 when determining the width g. In the direction of the axis of rotation 50 of the hose reel 20, the second side wall 25 protrudes beyond the outer contour of the housing 2 by less than 10%, in the exemplary embodiment by less than 5% of the width g of the side wall.

As can be seen in FIGS. 1 and 4, a receptacle 9 for the hose reel 20 is formed by the housing 2. The receptacle 9 engages over the hose reel 20 at least partially on its circumferential side. The receptacle 9 is formed by a first housing component of the housing 2. The first housing component is connected to a second housing component of the housing 2 to form a unit.

What is claimed is:

1. A pressure washer, comprising:
a high-pressure pump (10) by which cleaning fluid can be pressurized in the pressure washer (1);
a hose reel (20), which is mounted so that it can rotate about an axis of rotation (50);
a reel hose (21), which can be wound onto and unwound from the hose reel (20); and
a housing (2),
wherein the high-pressure pump (10) is arranged in the housing (2),
wherein the high-pressure pump (10) comprises at least one piston (11), which can be moved back and forth in a direction of movement (49) to generate pressure on the cleaning fluid,
wherein the high-pressure pump (10) has a middle axis (48) running in the direction of movement (49) of the at least one piston (11),
wherein the cleaning fluid can be conveyed to the reel hose (21) by the high-pressure pump (10) during operation of the pressure washer (1),
wherein the axis of rotation (50) runs transversely to the direction of movement (49) of the at least one piston (11), and
wherein the axis of rotation (50) intersects the high-pressure pump (10).

2. The pressure washer according to claim 1,
wherein the axis of rotation (50) of the hose reel (20) intersects the middle axis (48) of the high-pressure pump (10).

3. The pressure washer according to claim 1,
wherein the axis of rotation (50) of the hose reel (20) and the middle axis (48) of the high-pressure pump (10) are oriented perpendicularly relative to one another.

4. The pressure washer according to claim 1,
wherein the hose reel (20) has a reel spacing (a) from the middle axis (48) measured in the direction of the axis of rotation (50) of the hose reel (20),
wherein the pressure washer (1) has a maximum width (b) measured in the direction of the axis of rotation (50), and
wherein the reel spacing (a) is at most 50% of the maximum width (b).

5. The pressure washer according to claim 4,
wherein the hose reel (20) has a reel width (c) measured in the direction of the axis of rotation (50), and
wherein the reel spacing (a) is at most 70% of the reel width (c).

6. The pressure washer according to claim 4,
wherein a reel width (c) is at most 60% of the maximum width (b) of the pressure washer (1).

7. The pressure washer according to claim 1,
wherein the hose reel (20) is rotatably mounted on a fluid distributor piece (3),
wherein the fluid distributor piece (3) is held in a rigid connecting element (30),
wherein the rigid connecting element (30) is directly connected to a rigid base body (13) of the high-pressure pump (10), and
wherein, during the operation of the pressure washer (1), the cleaning fluid flows from the rigid base body (13) through the rigid connecting element (30) to the fluid distributor piece (3).

8. The pressure washer according to claim 7,
wherein no flexible line piece is arranged between the fluid distributor piece (3) and the high-pressure pump (10).

9. The pressure washer according to claim 7,
wherein no flexible line piece is arranged between the fluid distributor piece (3) and the rigid base body (13) of the high-pressure pump (10).

10. The pressure washer according to claim 1,
wherein the high-pressure pump (10) projects into the hose reel (20) in the direction of the axis of rotation (50).

11. The pressure washer according to claim 7,
wherein the rigid connecting element (30) of the high-pressure pump (10) projects into the hose reel (20) in the direction of the axis of rotation (50).

12. The pressure washer according to claim 9,
wherein the high-pressure pump (10) overlaps the hose reel (20) with respect to the direction of the axis of rotation (50) over at least 30% of a reel width (c).

13. The pressure washer according to claim 7,
wherein the hose reel (20) has, on its inner outer side (22) turned towards the high-pressure pump (10), a receiving chamber (23) located radially inwards with respect to the axis of rotation (50).

14. The pressure washer according to claim 13,
wherein the receiving chamber (23) is designed to receive a cleaning supply line (32) for adding cleaning agent to the cleaning fluid.

15. The pressure washer according to claim 14,
wherein the receiving chamber (23) has a maximum diameter (d1) measured in a direction perpendicular to the axis of rotation (50), and
wherein the maximum diameter (d1) is greater than a diameter (d2) of the fluid distributor piece (3) measured in the direction perpendicular to the axis of rotation (50).

16. The pressure washer according to claim 8,
wherein the rigid connecting element (30) comprises a cleaning supply opening (31) for adding cleaning agent to the cleaning fluid.

17. The pressure washer according to claim 16,
wherein the cleaning supply opening (31) is arranged in a region of the hose reel (20) with respect to the direction of the axis of rotation (50).

18. The pressure washer according to claim 1,
wherein the pressure washer (1) comprises a battery pack (4) for supplying power to a drive (5) of the high-pressure pump (10),
wherein the pressure washer (1) has a battery compartment (6) for receiving the battery pack (4), and
wherein the battery compartment (6) and the hose reel (20) at least partially overlap one another with respect to the direction of the axis of rotation (50).

19. The pressure washer according to claim 18,
wherein the battery compartment (6) and the high-pressure pump (10) at least partially overlap one another with respect to the direction of the axis of rotation (50).

20. The pressure washer according to claim 18,
wherein the high-pressure pump (10), a drive (5) for the high-pressure pump (10), and the battery compartment (6) are arranged one behind another with respect to the direction of the middle axis (48).

21. The pressure washer according to claim 1,
wherein the hose reel (20) forms a part of an outer contour of the pressure washer (1).

22. The pressure washer according to claim 1,
wherein the hose reel (20) protrudes in the direction of the axis of rotation (50) by less than 35% of its reel width (c) beyond an outer contour of the housing (2).
